(19) United States
(12) Patent Application Publication
(10) Pub. No.: US 2010/0169395 A1
(43) Pub. Date: Jul. 1, 2010

(54) DEVICE AND METHOD FOR FILTERING A FILE SYSTEM

(75) Inventors: DONALD RAY BRYANT-RICH, HAIFA (IL); DANIEL ISAAC GOODMAN, BEIT SHEMESH (IL); JUDAH GAMLIEL HAHN, OFRA (IL)

Correspondence Address: TOLER LAW GROUP, 8500 BLUFFSTONE COVE, SUITE A201, AUSTIN, TX, 78759, US

(73) Assignee: SANDISK IL LTD., KFAR SABA (IL)

(21) Appl. No.: 12/344,389

(22) Filed: Dec. 26, 2008

(51) Int. Cl. G06F 17/30; G06F 12/00

(52) U.S. Cl. 707/831; 726/3; 707/E17.01; 707/E17.032

(57) ABSTRACT

A host is provided with a filtered file system based on the native file system of a local storage device and other relevant factors. A filter interfaces with the local storage device and the host, and a controller reads the native file system, establishes access criteria for the host, and creates a logical structure of sectors in a volatile memory based on the access criteria to provide the filtered file system. The filter can also use a given host to read the native file system and to create the logical structure of sectors based on access criteria established for a different host.

### RELATED APPLICATIONS

This patent application is related to and incorporates by reference the patent applications entitled “A STORAGE DEVICE MANAGING PLAYABLE CONTENT” (Attorney Docket No. MSA-1277-US); “METHOD AND APPARATUS FOR PROVIDING ACCESS TO FILES BASED ON USER IDENTITY” (Attorney Docket No. MSA-1278-US); and “A STORAGE DEVICE PRESENTING TO HOSTS ONLY FILES COMPATIBLE WITH A DEFINED HOST CAPABILITY” (Attorney Docket No. MSA-1235-US) in that each share a common inventor (Yehuda Hahn) and were all filed on the same day.

### BACKGROUND

Many commonly used devices, e.g., specialized data processing hosts, such as mobile telephones or DVD players, are characterized by two limitations: first, they support only a limited set of file types, and second, they have relatively low processing power (e.g. as compared to personal computers). Routinely, these host devices are used to access data files from peripheral storage devices that also contain files that the hosts cannot process. Since the host device must process the file system of the storage device to extract the files it supports, the presence on the storage device of files not processable by the host causes an excessive load on the processing power of the host, resulting in unwanted delays for users of the host device.

In the example of a DVD player accessing a USB flash drive for movie files, the USB flash drive may also contain files that the DVD player cannot support. Despite safeguards that might be in place to guard against destructive effects of non-supported files, the mere presence of the non-supported files decreases the DVD player's processing power available for desired tasks. For instance, if the DVD player is designed to display on the screen of an attached television the entire list of files stored on the USB flash drive, a portion of the limited processing power of the DVD player must be diverted to display information that is not of interest to many users. Even if non-supported files are not displayed, the DVD player must still devote resources to determine that they are not supported. As a result, a user must wait longer to see the desired information on the television screen and subsequently to play the desired program.

In addition to processing power, another resource that is limited for many hosts is the size of the associated display. For example, an MP3 player or a mobile telephone with MP3 capability may not have a large enough display area to conveniently display the entire names of the files that are stored on an attached transient storage device SD memory card. For example, for a list of filenames “Fifties Favorite: Elvis Presley's ‘All Shook Up,’” “Fifties Favorite: Elvis Presley's ‘Love Me Tender,’” “Fifties Favorite: Elvis Presley's ‘Jailhouse Rock,’” and so on, the MP3 player would not display distinguishing information if filenames were truncated before the thirty-fifth character, as may be done to save display space. If the MP3 player instead displayed the entire file names, the MP3 player could not display as many file names at one time.

Accordingly, it would be desirable to be able to filter the files stored in a peripheral storage device before the files are presented to a host. Thereby, limited resources of the host, such as processing power and display space, could be focused upon the data of interest.

### SUMMARY

The present inventors have developed devices and methods for filtering the data of a local storage device before they are provided to a host. Such filtering reduces the demand on host resources, such as processing power and display area. Embodiments of the invention include a filtering method, a filtering device, and a filtering device combined with the local storage device.

According to an example embodiment, a device for filtering a file system of a local storage device has a local storage device interface, a host interface, and a controller. The local storage device interface is for communicating with a local storage device, which has a native file system, and the host interface is for communicating with a host. The controller is also operationally connected to the local storage device interface and to the host interface, and it is operative to read the native file system of the local storage device, to establish access criteria for a host, and to create a logical structure of sectors in a volatile memory based on the access criteria to provide a filtered file system.

The device for filtering a file system may further include the volatile memory in which the logical structure of sectors is created. Also, the device for filtering a file system may further include a wireless receiver operative to provide signals to the controller.

In the device, the controller may create the filtered file system based on host attributes. The filtered file system may filter the native file system according to one or more file-level conditions.

The local storage device interface of the device for filtering a file system may comply with the USB standard. The host interface may be a wired or wireless interface. The wired or wireless interface may comply with the USB standard.

According to another example embodiment, a local storage assembly may have a local storage device and a device for filtering a file system as discussed above. The local storage device in this embodiment has a native file system.

Also disclosed herein is a method of filtering a file system to be provided by a local storage device to a host. The method includes reading sectors of a native file system of a local storage device, establishing access criteria for a host, and creating a logical structure of sectors in a volatile memory based on the access criteria to provide a filtered file system. The reading of the sectors of the native file system may include communicating in compliance with the USB standard. The access criteria for the host may be established according to a file-level condition.

The method may include determining attributes of a host, wherein the access criteria for the host are established in accordance with the attributes of the host. The determining of the attributes of the host may include receiving information about the attributes from the host. The information about the attributes from the host may be received in a message conforming to the IEEE 1667 Probe command. The determining of the attributes of the host may include detecting a type of host based on communication heuristics. Also, the determining of the attributes of the host may include receiving a signal external to the local storage device and the host.

The method may include pre-configuring the local storage device for at least one specific type of host. Also, the method may include providing the filtered file system to a host through a wired interface or wireless interface, and the interface may comply with the USB standard.

The method may include additional elements. For example, the method may include requiring authentication before allowing the host access to at least a portion of data stored in the native file system. Also, the method may include reading the sectors of the native file system again after creating the logical structure of sectors in the volatile memory, thereby detecting changes that have occurred in the native file system after creating the logical structure of sectors in the volatile memory, and updating the sectors in the volatile memory to produce an updated filtered file system. Further, the creating of a logical structure of sectors may include renaming files of the native file system stored in the local storage device. Additionally, the filtered file system may be a transformation of the native file system created by changing a hierarchy or organization of a file structure of the native file system.

Further disclosed herein is a method of filtering a file system to be provided by a local storage device to a host. The method includes operating a first host to read sectors of a native file system of a local storage device, establishing access criteria for a second host, and creating a logical structure of sectors in a volatile memory based on the access criteria a filtered file system. The method may include requiring authentication before allowing the first host access to at least a portion of data stored in the native file system and/or allowing the second host access to at least a portion of data stored in the native file system.

Example embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIG. 1A illustrates an example embodiment of a device for filtering a file system;

FIG. 1B illustrates a flow chart representing an example embodiment of a method of filtering a file system, which method may be performed by the filter of FIG. 1A;

FIG. 2A illustrates an example directory table of a native file system, which may be stored in a storage device that is operationally connectable to the filter of FIG. 1A;

FIGS. 2B-2E illustrate example sectors of the directory table shown in FIG. 2A, for creating a logical structure for providing a filtered file system;

FIGS. 3A-3F illustrate flow charts representing variations of the example embodiment illustrated in FIG. 1B;

FIG. 4 illustrates a flow chart representing an alternative example embodiment to the embodiment illustrated in FIG. 1B; and

FIGS. 5A and 5B illustrate flow charts representing variations of the example embodiment illustrated in FIG. 4.

### DETAILED DESCRIPTION

The claims below will be better understood by referring to the present detailed description of example embodiments. This description is not intended to limit the scope of claims but instead to provide examples. Described first is an example embodiment of a filter in accordance with the present invention. Described next are multiple example embodiments of methods of filtering in accordance with the present invention.

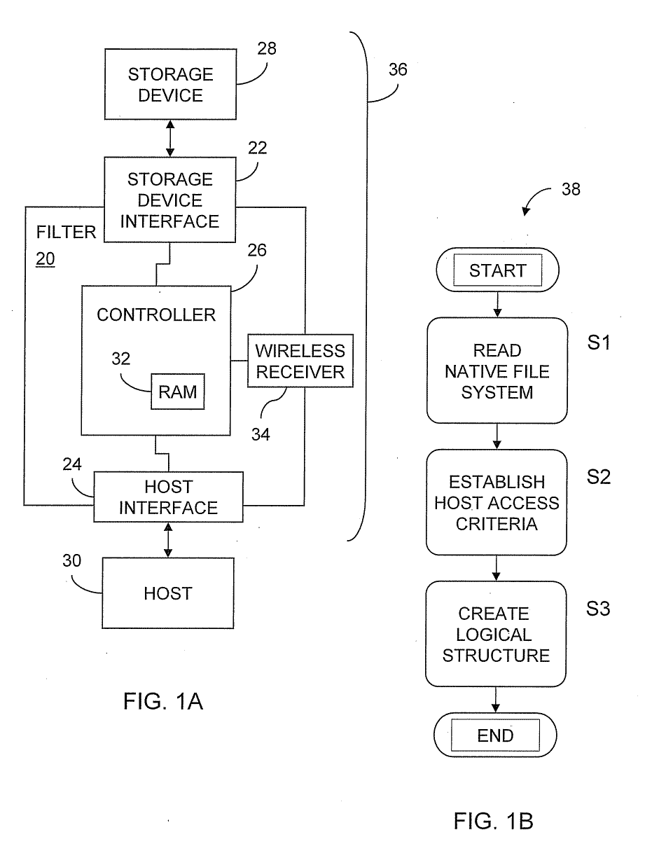

FIG. 1A illustrates an example embodiment of a device for filtering a file system. The device, a filter 20, has a local storage device interface 22, a host interface 24, and a controller 26.

The local storage device interface 22 operationally connects a local storage device 28 to the filter 20. In the context of the present disclosure, the term “local storage device” refers to a storage device having a point-to-point connection and a master/slave relationship with a host (the host being the master and the local storage device being the slave). The term “peripheral storage device” is used herein interchangeably with the term “local storage device.” Local storage devices applicable to the instant disclosure include but are not limited to those that comply with any of the following formats: ATA, SCSI, IEEE 1394, USB (mass storage device class).

The preceding abbreviations are known in the art as follows. ATA refers to “Advanced Technology Attachment,” which is a disk drive interface standard. SCSI refers to “Small Computer System Interface,” which is a processor-independent standard for a parallel bus for interfacing between a computer and intelligent devices (for example, hard disks, CD-ROMs, and scanners). (IEEE refers to the Institute of Electrical and Electronics Engineers, a professional society focusing on electrical engineering interests.) “IEEE 1394” refers to a serial bus interface standard offering high-speed communications and isochronous real-time data services. USB refers to “Universal Serial Bus,” which is an external peripheral interface standard for communicating between a computer and external peripherals over cable using bi-serial transmission.

The local storage device 28 has a native file system (a “first” file system) stored in a non-volatile memory of local storage device 28. The term “native file system” references the physical storage of the storage device 28, that is, file system information (e.g. regarding format and organization), metadata, and file contents or data. The local storage device interface 22 selected for the filter 20 may be one that complies with the USB standard (e.g. to accommodate a USB local storage device), and the local storage device interface 22 may be a wired or a wireless interface.

The host interface 24 operationally connects a host 30 to the filter 20. The term “host” is used interchangeably with the term “host device.” Example hosts include a personal computer, a mobile phone, a camera, a DVD player, a television, and a network-attached storage server. The filter 20 thus serves as an interface between host 30 and local storage device 28. The host 30 and the local storage device 28 may be such as are conventionally connected directly to each other. The host interface 24 selected for the filter 20 may be one that complies with the USB standard, and the host interface 24 may be a wired or a wireless interface.

The controller 26 is operationally connected to the local storage device interface 22 and to the host interface 24. As discussed in more detail below, the controller 26 reads the sectors of the native file system of the local storage device 28, establishes access criteria for the host 30, and creates a logical structure of sectors in a volatile memory based on the access criteria to provide a second file system.

The second file system need not have any physical embodiment and is therefore distinct from the native file system. The second file system provides and/or organizes files differently than does the native file system, in order to permit or facilitate interaction between applications, devices, etc. that may have different or differently organized native file systems. For example, the second file system may “filter” the files of the native file system, showing only certain files of the native file system (selected based on certain criteria) as available or present in the local storage device. In the context of this disclosure, the second file system may hereafter be referred to as a filtered file system.

The second file system includes a specification of the relationship between the files (or representation/organization thereof) of the second file system and the files (or representation/organization thereof) of the native file system, e.g., a mapping between the logical addresses specified within structures of the second file system and the logical addresses specified within structures of the native file system.

The native file system and the second file system do not need to be of the same type. As a non-limiting example, one file system could be JFFS2 and the other could be FAT. Each of the native file system and the second file system may be another type of file system suitable for removable storage, as will be understood by one of ordinary skill in the art.

The volatile memory, in which controller 26 generates the logical structure of sectors, may be a RAM 32 embedded within the controller 26, as shown in FIG. 1A. In alternate embodiments, the volatile memory can be a flash memory within the filter 20 but separate from controller 26. In yet other embodiments, the volatile memory may reside in the local storage device 28.

Optionally, the filter 20 may have a wireless receiver 34 to receive signals from an external source (e.g. host 30 or local storage device 28) for the controller 26. In a different example embodiment, the filter 20 would have a wired connection to the host 30 and the controller 26 may receive external signals through the wired connection mediated by the use of command buttons (not shown) located, e.g., on a casing of the filter 20. (The command buttons, when pressed, would send signals to the controller 26.) This arrangement may be used in place of (or in addition to) the arrangement in which the controller 26 includes a wireless receiver 34 to receive signals.

The various uses to which such external signals may be put, e.g., to provide information about the host type or host attributes (which is used to establish access criteria), or to authenticate a user, or to hide all files having specific metadata characteristics (i.e. to implement filtering according to a file-level condition) are discussed below in appropriate places throughout the application.

The local storage device 28 and the filter 20 together constitute a local storage assembly 36. In the context of the present disclosure, the term “local storage assembly” refers to the combination of a filter and a local storage device. The assembly 36 can function as portable storage for multiple hosts, wherein the filter 20 of the assembly 36 can be designed to create for each of the multiple hosts a second (filtered) file system appropriate for the respective host. (The filter 20 can effectively operate as multiple different filters, and can but need not be configured as multiple physical devices.) In this way, each of the multiple hosts can operate more efficiently than if the file system of the local storage assembly 36 were provided in the same way (e.g. providing the same filtered file system) for each host.

As will be appreciated by those of ordinary skill in the art, filter 20, local storage device interface 22, host interface 24, and controller 26 may be implemented by a suitable combination of hardware, software, and/or firmware, as will be understood by those of skill in the art.

Another example embodiment of the present invention, illustrated by flow chart 38 in FIG. 1B, is a method of filtering a file system provided by a local storage device to a host. The method includes reading sectors of a native file system of a local storage device (step S1), establishing access criteria for a host (step S2), and creating a logical structure of sectors in a volatile memory to provide a second (filtered) file system (step S3). The method may be performed by the filter 20 of the embodiment of FIG. 1A while interacting with the local storage device 28 and the host 30.

As for step S1, the sectors of the native file system of the local storage device may be read by any means known to one skilled in the art. For example, the reading could include communicating in compliance with the USB standard.

As for step S2, the access criteria for a host are established. The access criteria are established based on host attributes. Host attributes may be explained in terms of the following examples. (As mentioned above, example hosts include a personal computer, a mobile phone, a camera, a DVD player, a television, and a network-attached storage server, among others.) One example of a host attribute would be the ability to process only certain file types. For instance, the host could be a DVD player that is only able to process files in DVD format. By making use of filter 20 to provide to the host a filtered (second) file system showing only files in DVD format, the DVD player does not need to allocate any of its limited resources to process unsupported files. Another example of a host attribute would be the bit rate at which the host is able to render data. By creating a filtered (second) file system that presents to the host only files suitable for consumption (for example, playback) at bit rates supported by the host, the host does not need to allocate resources to process unsupported files. Still another example of a host attribute is the ability (restriction) of being able to read only those file systems that are based on (or compatible with) the host's native operating system. Such a host attribute could be possessed by a host such as a personal computer. Other examples of host attributes will be appreciated by those skilled in the art.

Now that it is understood what is meant by “host attributes,” the term “access criteria” can be understood, as particular access criteria may be deemed to be effectively defined in terms of corresponding host attributes. “Access criteria” are the criteria a file must satisfy (e.g. the characteristics that a file must possess) for the file to be compatible with given host attributes. For example, if the host has the attribute that it can only process files in DVD format, the corresponding access criterion is that a file must be in DVD format. Only files satisfying this criterion would be permitted to be presented by the storage device to the host.

The access criteria may be stored in a volatile memory, such as in a RAM of the filter or the storage device, for use when processing read requests. Alternatively, the access criteria may be stored in a non-volatile memory in either the filter or the storage device.

Returning to the flowchart 38 of FIG. 1B, at step S3, to create a logical structure of sectors based on the host's access criteria, a processor, such as controller 26 of filter 20 in FIG. 1A, allocates a structure in designated storage, such as in RAM 32 of filter 20. This structure is a logical structure to be selectively populated as follows with corresponding data from the native file system.

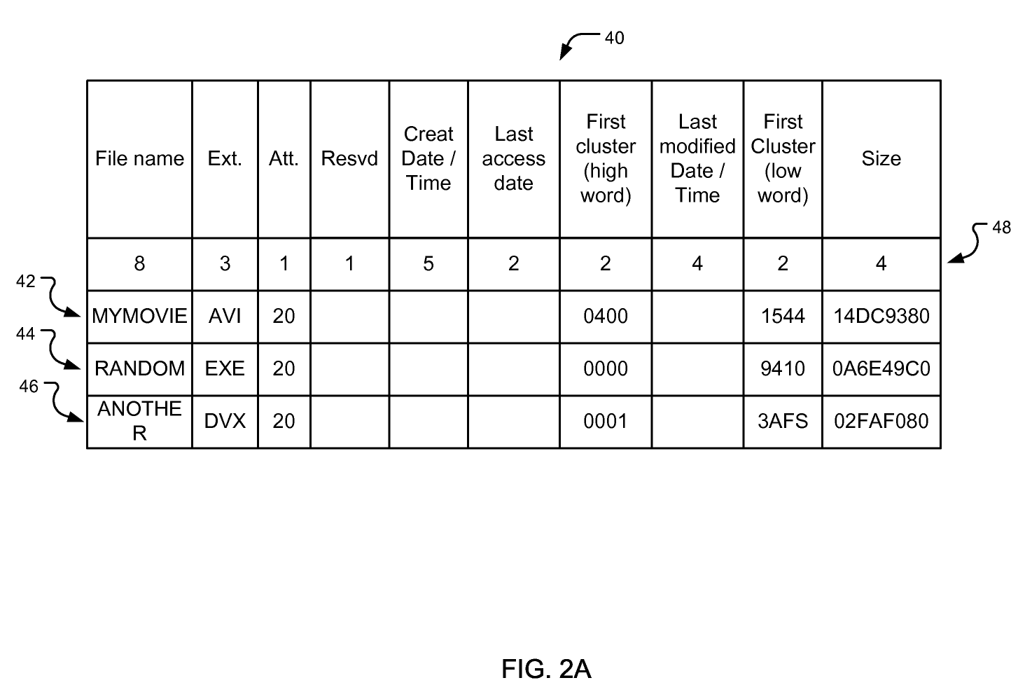

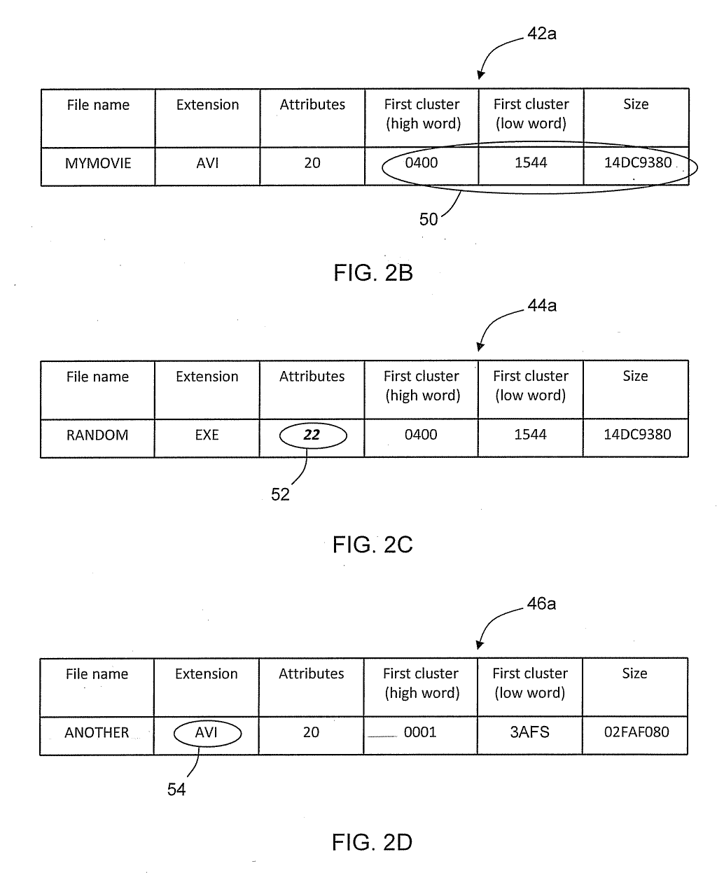

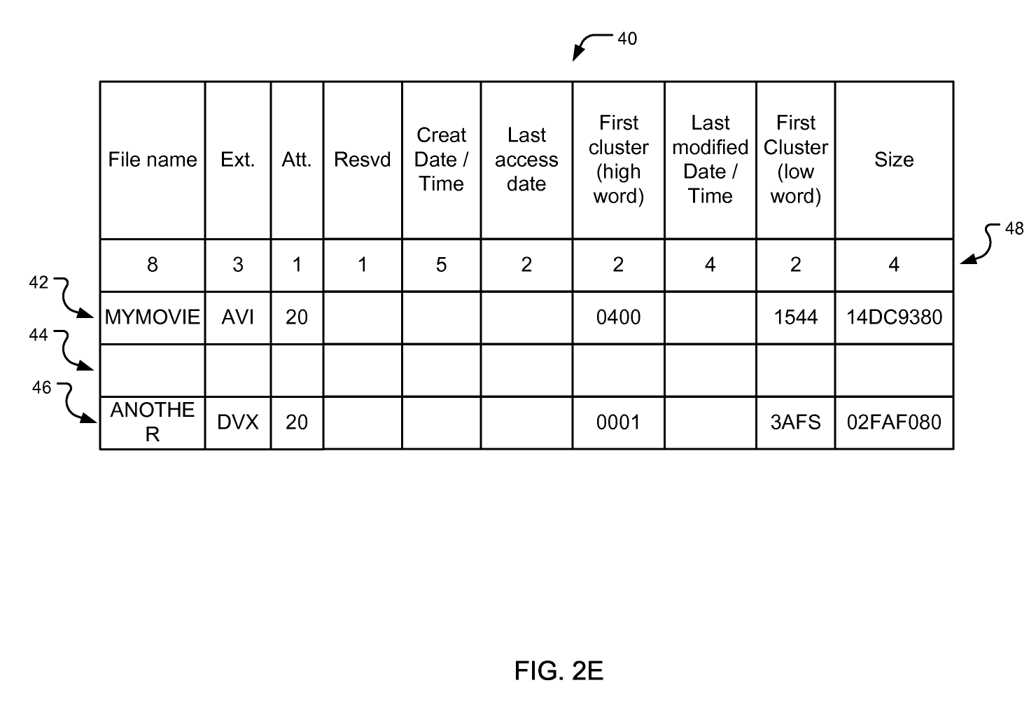

The processor determines, based on the access criteria, which files in the native file system may be represented to the host in their original form (discussed below with reference to FIG. 2B), which files must be altered in some way (for example, by changing the filename extension) (discussed below with reference FIGS. 2C and 2D), and which files cannot be represented at all (discussed below with reference to FIG. 2E). (The term “alteration” of a file is meant to include alteration of file contents and/or file metadata.) The processor then populates the logical structure with sectors of the native file system accordingly. That is, for sectors containing only directory entries that may be represented to the host in their original form, the processor creates a mapping in the logical structure to enable the storage device to return to the host the unmodified contents of the corresponding files in response to read requests from the host. For sectors containing at least one directory entry that must be altered in some way from its original form, the processor places substitute information in the logical structure. For example, if the filename extension is to be changed, the logical structure will represent to the host the substitute filename extension, but in accordance with the mapping in the logical structure the storage device will otherwise return to the host the unmodified contents of the files in response to read requests from the host. Last, for sectors containing at least one directory entry that is not to be represented to the host at all, the processor modifies the logical structure and produces sectors containing only the directory entries that may be represented to the host, substituting these sectors for the sectors requested by the host. Thus, the corresponding files do not appear in the logical structure, and the host would therefore not be expected to request a corresponding file, and the storage device would not return such a file to the host. With the logical structure created accordingly, a filtered file system is now provided to the host.

FIG. 2A represents an example directory table 40 of a native file system of a storage device, such as local storage device 28 in FIG. 1A. Directory table 40 has three directory entries 42, 44, and 46 with the filenames and extensions MYMOVIE.AVI, RANDOM.EXE, and ANOTHER.DVX, respectively. A “directory table” is a special type of file that represents a directory (also known as a folder). Each file or directory stored within the represented directory is represented by a 32-byte entry in the table. Each entry in the directory table 40 may include or have associated with it a set of data such as the file's or directory's name, extension, attributes (archive, directory, hidden, read-only, system, and volume label), date and time of creation of the file/directory, address of the first cluster of the file/directory's data and size of the file.

Directory table 40 includes the following exemplary fields, which are also known as “directory elements” (the number of bytes allotted for each field of directory table 40 is indicated in the second row 48): (1) “File name” (8 bytes), (2) file extension (i.e.,” Extension”, 3 bytes), (3) “Attributes” (1 byte), (4) “Reserved” (1 byte), (5) “Create Date/Time” (5 bytes), (6) “Last access date” (2 bytes), (7) “First cluster” (high word, 2 bytes), (8) “Last modified Date/Time” (4 bytes), (9) “First cluster” (low word, 2 bytes), and (10) file size (i.e., “Size”, 4 bytes). The numbers in the directory table 40 are illustrated in hexadecimal format. (For convenience, the illustrated directory entries are only a partial representation of the actual directory structure.) This entry structure is valid specifically for FAT32 format file systems as implemented in Windows XP and Vista. FAT16 and legacy DOS format file systems use a slightly different structure. For example, FAT16 file systems use a structure that does not include the high word of the first cluster number, and the legacy DOS structure (used by some DVD players for reading files) has a reserved block of 10 bytes instead of 1 byte, followed by the low word of the first cluster number. Embodiments discussed herein may employ file system formats, and implementations, other than those mentioned here, as will be appreciated by those of skill in the art.

FIGS. 2B-2D show example modified structures 42a, 44a, and 46a of directory entries 42, 44, 46, respectively, of directory table 40 of FIG. 2A. These structures 42a, 44a, and 46a are stored in designated storage, such as in RAM 32 of filter 20, to provide a filtered file system. Some of the fields of directory table 40, for example, the “Reserved” and timestamp fields (fields (4), (5), and (8) of directory table 40), are not relevant to the present discussion and thus are omitted in the illustrations for clarity.

FIG. 2B illustrates the structure 42a, which corresponds to the data file MYMOVIE.AVI in the native file system (entry 42 in FIG. 2A). Assuming the host is a DVD player, such that only DVD format files are permitted to be presented to the host by the access criteria, the data file MYMOVIE.AVI in the native file system may be represented to the host in its original form, and therefore the structure 42a represents to the host the same values of high and low words of the first cluster and of the size (the fields indicated at 50 in FIG. 2B) as are in the corresponding fields of the directory entry 42 in the directory table 40 of the native file system shown in FIG. 2A. This representation in the structure 42a enables the storage device to return to the host the unmodified contents of the file MYMOVIE.AVI (i.e. the contents of that file in the native file system) in response to a host read request for sectors within the file.

FIG. 2C illustrates the structure 44a, which corresponds to the executable file RANDOM.EXE in the native file system (entry 44 in FIG. 2A). Assuming, as before, that the host is a DVD player, it is understood that the host has the attribute that it cannot process an executable file. Therefore, the filter represents to the host that the file RANDOM.EXE is hidden.

Accordingly, the processor of the filter modifies the attribute “20” of the file RANDOM.EXE (i.e. the attribute of directory entry 44 shown in FIG. 2A) by executing an OR operation (a logical operation between two binary operands) between that attribute (first operand) and the value “02” (second operand; the attribute value 02 indicating in this example that the file is to be hidden) to obtain the attribute value “22,” shown in FIG. 2C at 52. The operating system of the host understands that the resulting value “22” is an indication that the file should not be displayed for selection by a user of the host.

FIG. 2D illustrates the structure 46a, which corresponds to the data file ANOTHER.DVX in the native file system (entry 46 in FIG. 2A). Assume, as before, that the host is a DVD player. In this case, it is understood that the host has the attribute that it cannot process this file because the file's name has a “DVX” extension, but the data in the file is such that the host could process the file if the extension of the filename were instead “AVI”. Accordingly, the processor of the filter changes the extension “DVX” to “AVI” as shown in FIG. 2D at 54, and then the host can process the file.

FIG. 2E illustrates the structure 48a, which corresponds to the executable file RANDOM.EXE in the native file system (entry 44 in FIG. 2A). Assuming, as before, that the host is a DVD player, it is understood that the host has the attribute that it cannot process an executable file. Therefore, the filter removes the directory entry corresponding to the file RANDOM.EXE. That is, the file RANDOM.EXE is not be represented to the host in the filtered file system. (Unlike in FIG. 2C, wherein the file is marked as hidden, in the case of FIG. 2E, the file is completely unavailable to the host.) Thus, FIG. 2E represents an alternative way of addressing a host having the host attribute discussed with reference to FIG. 2C.

Of course, the above discussion of FIGS. 2A-2E employs only a single example of host type, host attribute and concomitant access criteria. The embodiments disclosed in this application are applicable to a wide range of other host types, host attributes and concomitant access criteria. It is also understood that according to the embodiments disclosed herein other fields of a directory structure including those fields not illustrated herein may be modified in manners similar to those described above.

As the above examples show, the filtered file system may be created based on information about the host attributes. In addition to or as an alternative to creating a filtered file system based on the host's attributes, the filtered file system may be designed to filter the native file system according to one or more file-level conditions. An example of filtering according to a file-level condition would be omitting any file whose metadata (e.g. file name) includes certain information (e.g. a certain text string, e.g. the text string “confidential” or “adult”). Another example of file-level condition filtering would be translating all file names corresponding to a format unsupported by a given host (e.g. host 30) to filenames corresponding to a format supported by the given host, as shown above in the discussion of FIG. 2D.

Yet another example of file-level condition filtering would be removing from all file names a common prefix shared by all file names. In this case, the creating of a logical structure of sectors (step 3 of FIG. 1B) can include e.g. renaming files of the native file system stored in the local storage device. An example of renaming files accordingly would be, for a set of filenames each having the same initial characters, to remove the initial characters of each file name. Thus, if the names of files on a local storage device were “Fifties Favorite: Elvis Presley's ‘All Shook Up,’” “Fifties Favorite: Elvis Presley's ‘Love Me Tender,’” and “Fifties Favorite: Elvis Presley's ‘Jailhouse Rock,’” the initial identical characters would be removed and the names of the renamed files would be “All Shook Up,” “Love Me Tender,” and “Jailhouse Rock.” A list of the renamed files would more easily fit a display screen of limited size, as is the case for many MP3 players and mobile telephones. This would avoid the situation in which the display shows only the same initial characters and thereby does not permit a user to distinguish the different files by looking at the listing of file names on the display.

The filtered file system could also be a transformation of the native file system created by flattening or otherwise changing the hierarchy or organization of the file structure of the native file system. For example, the filtered file system may provide files from different folders or directories in the native file system as being all in the same folder or directory, or the filtered file system may provide files that are unsorted in the native file system as being sorted into different folders (for example, according to their prefix or file type), or files that are sorted in the native file system as being sorted in a different fashion, or the like.

Remapping files to folders could be used to retain, in the names of the folders, information originally contained in the file names that might otherwise be lost due to truncation of the file names by the host. For example, if the files start with “my vacation Spain—week 1—”, “my vacation Spain—week 2—”, “my vacation Florida—”, and “kids baseball games—”, the generated file structure might be as below based on commonality of prefixes between files. Note that the user would not need to edit the file names or create the folder structure.

```
\my vacation
    \Spain
        \week 1
        \week 2
    \Florida
\kids baseball games
```

The filtered file system may be a transformation of the native file system created by converting the format of some or all of the files of the native file system. For example, all files of a given format unsupportable by the host 30 could be converted to files of a format supportable by the host 30. Other ways of creating the filtered file system, including other ways of filtering, and other file-level conditions will be appreciated by one of ordinary skill in the art. Thus, the filtered file system can be designed to present files in ways that are convenient to a user, e.g., according to which types of host device the user uses.

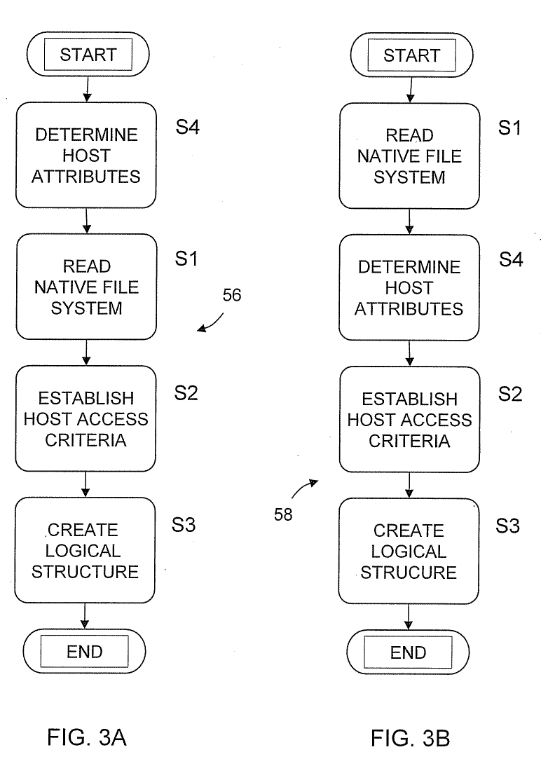

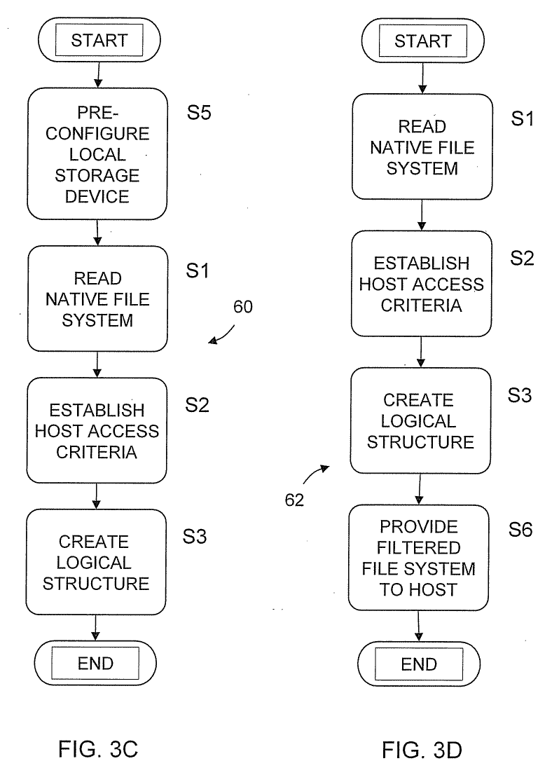

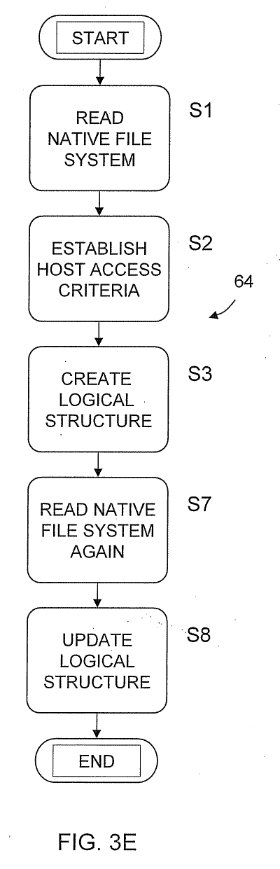

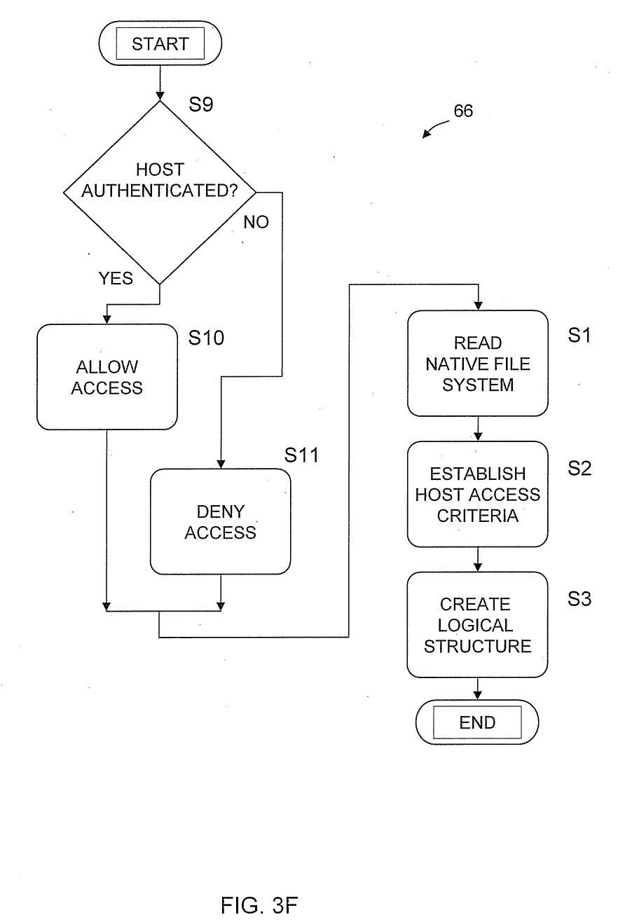

In a variation of the method shown in FIG. 1B, the method of filtering a file system includes a step of determining the attributes of a host (step S4), which was discussed above. Example embodiments of this variation are represented by the flow chart 56 in FIG. 3A and by the flow chart 58 in FIG. 3B. Controller 26 of the filter 20 (FIG. 1A) can determine host attributes in a variety of ways, e.g. by receiving information about host type or host attributes from the host; by receiving information about host type or host attributes via external signals; or by deducing host attributes from host type as determined using communication heuristics. Further elaboration of some of these ways of determining host attributes is now presented.

External signals conveying host type or host attribute information may be received via a wireless receiver (e.g. wireless receiver 34 of FIG. 1A) or (in the case of a wired device) via command buttons, as discussed above with reference to FIG. 1A.

As for the controller 26 receiving the information about the host's type or attributes from the host, the host may send this information in a message that conforms to the IEEE 1667 Probe command.

Determining host attributes by detecting host type based on communication heuristics means analyzing the requests sent by the host, inferring the host type according to a conjecture based on this analysis, and deducing the host attributes from the inferred host type. In some example scenarios, as soon as the storage device is operatively connected to a host (e.g. a DVD player), the host will send approximately 25 to 30 initial commands (such as query commands to determine the device type) to the storage device before the host will begin attempting to read the file system of the storage device. The timing of the commands, their order, and similar variables serve as parameters of a pattern, known as a communication pattern or communication signature. This pattern varies, i.e. is correlated, with host type (for at least some hosts), and thus can be recognized by the controller 26 as indicative of a particular type of host. It is known, for at least some hosts, that a host of given type has at least certain attributes. Thus, once host type is known, host attributes may be deduced therefrom. (Indeed the recognition of the communication pattern by the controller can be performed before the filter 20 needs to begin the processes of providing a filtered file system.).

As mentioned, another way to determine the attributes of the host is to receive a signal originating from a source that is external to both the local storage device and the host. For example, such a signal might be transmitted from a remote control transmitter. Alternatively, the signal might be sent to the processor, such as controller 26 of filter 20 in FIG. 1A, by pressing command buttons on a box enclosing the local storage device, thereby causing signals to be sent to the controller 26, as discussed above.

When the host attributes are determined, the access criteria for the host can be established in accordance with the determined host attributes, as explained above (FIG. 1B, step S2). Thus, the step S4 of determining the host attributes is completed before the step S2 of establishing the access criteria of the host, whether the former step is executed before the step S1 of reading the native file system (FIG. 3A) or thereafter (FIG. 3B). As another alternative, the step S4 of determining the host attributes may be executed concurrently with the execution of the step S1 of reading the native file system.

When the access criteria, corresponding to the host's attributes, have been established, the controller 26 can create the second (filtered) file system based thereon. Creating a second (filtered) file system, based on the host access criteria, has been described above, e.g. with reference to FIGS. 2A-2E.

As an alternative (or an addition) to determining host attributes on the fly, in another variation of the method shown in FIG. 1B, the method of filtering a file system includes pre-configuring the local storage device for one or more specific host types as represented by step S5 in the flowchart 60 of FIG. 3C. For example, the storage device 28 of FIG. 1A could be pre-configured for both a 1667-compliant personal computer and a specific type of DVD player that is not 1667-compliant. In practice, a 1667-compliant personal computer identifies itself to a storage device, but the non-1667-compliant DVD player does not. The storage device 28 may be pre-configured so as to assume that any host that does not identify itself as a 1667-compliant personal computer is the specific type of DVD player. (A 1667-compliant host identifies itself to a device.) Thus, the storage device 28 would make a determination as to the type of host to which it is connected, and filter 20 would adapt the native file system of the storage device 28 in accordance with the determined host type. The remainder of the method of FIG. 3C is the same as that of the method of FIG. 1B.

In yet another variation of the method shown in FIG. 1B, the method of filtering a file system includes providing the filtered file system to the host through either a wired or wireless interface as represented at step S6 in the flowchart 62 of FIG. 3D. Interfaces suitable for the execution of step S6 include but are not limited to those that comply with the USB, SD (Secure Digital™), or MMC (Multimedia Card) standards. The preceding steps, steps S1-S3, are the same as that of the method of FIG. 1B.

To accommodate the fact that the contents of a local storage device may change over time, another variation of the embodiment of FIG. 1B updates the filtered file system to reflect such changes. As represented by flowchart 64 of FIG. 3E, after the sectors of a native file system are read (step S1), the access criteria for a host are established (step S2), and the logical structure of sectors in a volatile memory are created to provide the second (filtered) file system (step S3), the following additional steps are executed to update the filtered file system. The method continues with reading the sectors of the native file system again (step S7) and updating the logical structure of sectors in the volatile memory so as to produce an updated filtered file system (step S8). Changes that have occurred in the native file system are thus detected in step S7, and the sectors are changed accordingly in step S8. An example of an update would be a new directory entry of the type shown in FIG. 2B being added to a RAM of a filter to indicate to a host that a new file now resides in a storage device.

FIG. 3F illustrates still another variation of the method shown in FIG. 1B. According to this variation, the method of filtering a file system includes a step of requiring authentication before allowing the host access to at least a portion of the data in the filtered file system. Authentication may be provided by any of various methods known in the art. For example, if the host is an IEEE 1667-compliant device, the authentication may be provided by the IEEE 1667 Authentication Silo.

According to this method (flowchart 66 of FIG. 3F), before reading sectors of the native file system of the local storage device (step S1), an inquiry is made by the controller of the filter to determine whether the host is authenticated (step S9). (As mentioned above, the controller may make use of received external signals to make this determination.). If the determination is made that the host is authenticated, the host will be allowed access to some or all of the data in the filtered file system (step S10). If the determination is made that the host is not authenticated, the host will be denied access to some of the data (step S11). The method continues with steps S1-S3 as in FIG. 1B. In alternate embodiments, a negative answer following step S9 causes the host to be denied access to all of the data in the local storage device, so the process can end at step S11; that is, the steps S1-S3 would not be executed. In still other alternate embodiments, steps S9-S11 may be executed after the step S1 and before the step S2. In still other alternate embodiments, steps S9-S11 may be executed concurrently with the execution of the step S1.

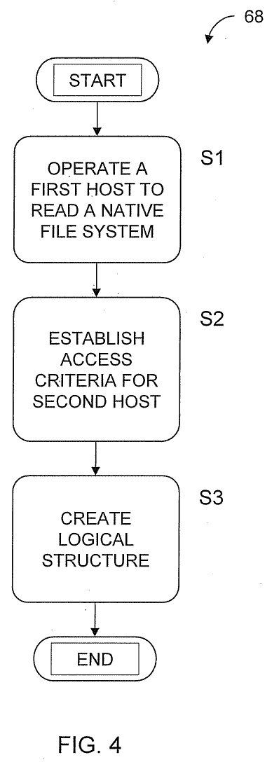

The flow chart 68 in FIG. 4 represents another example embodiment. This method of filtering a file system involves two hosts. Specifically, a local storage assembly (e.g. the local storage assembly 36 of FIG. 1A), including a filter and a local storage device, can be prepared by a first host for use with a second host. For example, a user could prepare a local storage assembly on a personal computer (a first host) for later use on a DVD player (a second host).

According to the method of FIG. 4, initially, the filter, such as the filter 20 of the embodiment of FIG. 1A, is connected to the local storage device and the first host.

The first host is then operated to read sectors of a native file system of the local storage device (step S1), as in step S1 of FIG. 1B.

Then, access criteria are established (step S2). Unlike in step S2 of the example embodiment of FIG. 1B, though, the access criteria are that of the second host instead of the first host. The first host may obtain the access criteria of the second host by receiving input from a user or from an internal database or the like. In other respects, though, the access criteria may be established and stored in the same manner as in step S2 of the example embodiment of FIG. 1B.

The next step is creating a logical structure of sectors based on the access criteria of the second host (step S3). This step may be performed in the same way as step S3 of the example embodiment of FIG. 1B.

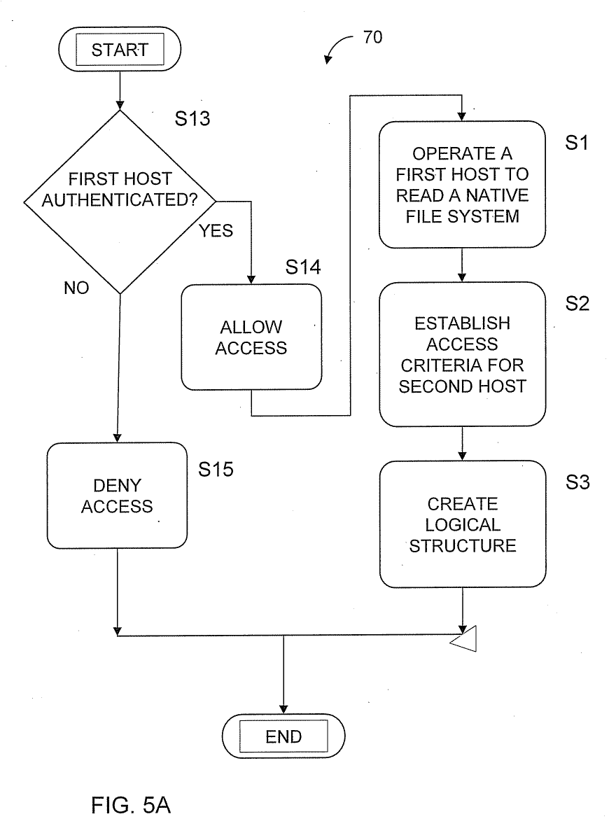

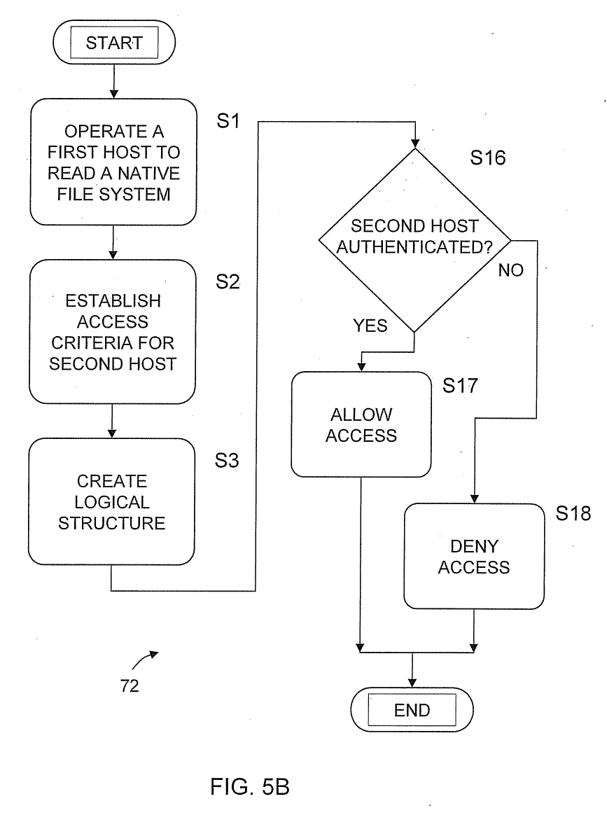

In a variation of the method shown in FIG. 4, the method of filtering a file system includes requiring authentication before allowing the first host access to at least a portion of the data in the file system. This example embodiment is illustrated in the flowchart 70 of FIG. 5A. Before the first host is permitted to read a native file system of the local storage device (step S1), an inquiry is made to determine whether the first host has been authenticated (step S13). If the answer is affirmative, the first host is allowed access to the file system (step S14). The process continues with steps S1-S3 as described with reference to FIG. 4. If the answer is negative, the first host is denied access to all the data (step S15) and thus cannot create a filtered file system for the second host.

In another variation of the method shown in FIG. 4, the method of filtering a file system includes requiring authentication before allowing the second host access to at least a portion of the data in the file system. This example embodiment is illustrated in the flowchart 72 of FIG. 5B. Steps S1-S3 are as described with reference to FIG. 4. After the sectors that map the logical structure into a filtered file system are generated (step S3), though, an inquiry is made to determine whether the second host has been authenticated (step S16). If the answer is affirmative, the second host is allowed access to some or all of the data in the filtered file system (step S17). If the answer is negative, the second host is denied access to all the data (step S18).

It is also possible to combine the embodiments illustrated in FIGS. 5A and 5B so as to require authentication of both the first and the second hosts in the manners described above.

Having thus described exemplary embodiments, it will be apparent that various alterations, modifications, and improvements will readily occur to those skilled in the art. Alternations, modifications, and improvements of the disclosed embodiments, though not expressly described above, are nonetheless intended and implied to be within the spirit and scope of the claims. Accordingly, the foregoing discussion is intended to be illustrative only; the invention is limited and defined only by the following claims and equivalents thereto.

What is claimed is:

1. A method of filtering a file system to be provided by a local storage device to a host, the method comprising:
reading sectors of a native file system of a local storage device;
establishing access criteria for a host; and
creating a logical structure of sectors in a volatile memory based on the access criteria to provide a filtered file system.

2. The method of claim 1, further comprising:
determining attributes of a host;
wherein the access criteria for the host are established in accordance with the attributes of the host.

3. The method of claim 2, wherein the determining the attributes of the host includes receiving information about the attributes from the host.

4. The method of claim 3, wherein the information about the attributes from the host is received in a message conforming to the IEEE 1667 Probe command.

5. The method of claim 2, wherein the determining the attributes of the host includes detecting a type of the host based on communication heuristics.

6. The method of claim 2, wherein the determining the attributes of the host includes receiving a signal external to the local storage device and the host.

7. The method of claim 1, further comprising:
pre-configuring the local storage device for at least one specific type of host.

8. The method of claim 1, wherein the access criteria for the host are established according to a file-level condition.

9. The method of claim 1, wherein the reading of the sectors of the native file system includes communicating in compliance with the USB standard.

10. The method of claim 1, further comprising providing the filtered file system to a host through a wired or wireless interface.

11. The method of claim 1, further comprising:
reading the sectors of the native file system again after creating the logical structure of sectors in the volatile memory, thereby detecting changes that have occurred in the native file system after creating the logical structure of sectors in the volatile memory; and
updating the logical structure of sectors in the volatile memory to produce an updated filtered file system.

12. The method of claim 1, wherein the creating of a logical structure of sectors includes renaming files of the native file system stored in the local storage device.

13. The method of claim 1, wherein the filtered file system is a transformation of the native file system created by changing a hierarchy or organization of a file structure of the native file system.

14. The method of claim 1, further comprising:
requiring authentication before allowing a host access to at least a portion of data stored in the native file system.

15. A method of filtering a file system to be provided by a local storage device to a host, the method comprising:
operating a first host to read sectors of a native file system of a local storage device;
establishing access criteria for a second host; and
creating a logical structure of sectors in a volatile memory based on the access criteria to provide a filtered file system.

16. The method of claim 15, further comprising:
requiring authentication before (i) allowing the first host access to at least a portion of data stored in the native file system and/or (ii) allowing the second host access to at least a portion of data stored in the native file system.

17. A device for filtering a file system of a local storage device, the device comprising:
a local storage device interface for communicating with a local storage device, the local storage device having a native file system;
a host interface for communicating with a host; and
a controller operationally connected to the local storage device interface and to the host interface, the controller being operative to read the native file system of the local storage device, to establish access criteria for the host, and to create a logical structure of sectors in a volatile memory based on the access criteria to provide a filtered file system.

18. The device of claim 17, wherein the controller creates the filtered file system based on host attributes.

19. The device of claim 17, further comprising:
the volatile memory in which the logical structure of sectors is created.

20. The device of claim 17, further comprising:
a wireless receiver operative to provide signals to the controller.

21. The device of claim 17, wherein the filtered file system filters the native file system according to one or more file-level conditions.

22. The device of claim 17, wherein the local storage device interface complies with the USB standard.

23. The device of claim 17, wherein the host interface is a wired or wireless interface.

24. The device of claim 23, wherein the wired or wireless interface complies with the USB standard.

25. A local storage assembly comprising:
a local storage device having a native file system; and
the device of claim 17.
